(19) United States
(12) Patent Application Publication
(10) Pub. No.: US 2009/0263139 A1
(43) Pub. Date: Oct. 22, 2009

(54) Method and apparatus for increasing voice service for an optical network terminal (ONT)

(75) Inventors: David H. Liu, Herndon, VA (US); Guy M. Merritt, Purcellville, VA (US); Fung-Chang Huang, Herndon, VA (US); Marc R. Bernard, Miramar, FL (US); Nabeel Zafar, Woodbridge, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 12/148,103

(22) Filed: Apr. 16, 2008

(51) Int. Cl. H04B 10/00

(52) U.S. Cl. 398/135

(57) ABSTRACT

An Optical Network Terminal (ONT) has a fixed number of voice ports. A system employing an example embodiment of the invention increases the number of voice ports without changing hardware in the ONT by employing an Analog Terminal Adaptor (ATA) expander and configuring the ATA expander through use of a Session Initiation Protocol (SIP) and other network resources already available in a network with which the ONT is associated. The ATA expander is configured to be compatible with the ONT and, thus the ONT can increase voice services without hardware changes to support growing demands by customers for access to voice services via increasing number of Customer Premises Equipment (CPE).

### BACKGROUND OF THE INVENTION

As use of voice services grows, so does the need for increased voice connectivity. Currently, an Optical Network Terminal (ONT), for example, has two voice ports with respective user agents to support voice services for multiple Customer Premises Equipment (CPE) devices. An ONT is a device in a Passive Optical Network (PON) that provides connectivity via the PON for a customer using the CPE, such as a Plain Old Telephone Service (POTS) telephone or Voice Over Internet Protocol (VoIP) telephone, to access voice services offered by network services providers. In operation, the ONTs establish voice services for each user agent up to two ports.

### SUMMARY OF THE INVENTION

A method or corresponding apparatus in accordance with an example embodiment of the invention includes a procedure for increasing voice service for an Optical Network Terminal (ONT). The procedure may request an Internet Protocol (IP) address from a Dynamic Host Configuration Protocol (DHCP) server. In the example embodiment, the DHCP is located upstream of the ONT, and the IP address corresponds to an address of an Analog Telephony Adapter (ATA) associated with the ONT on a downstream side of the ONT. After requesting the IP address, the procedure retrieves a configuration profile, for the ATA, conforming to a same Session Initiation Protocol (SIP) messaging protocol as used by the ONT. Next, the example procedure retrieves a user configuration profile for at least one user agent in the ATA and enables at least one user agent to register with a SIP server upstream of the ONT. After retrieving the user configuration profile, the procedure registers the at least one user agent of the ATA by using the user configuration profile to activate the at least one user agent for SIP service.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiment of the present invention.

FIG. 1 is a block diagram of a communications network providing increased voice service via a single port of an Optical Network Terminal (ONT) according to an example embodiment of the invention;

FIG. 2 is a block diagram of a detailed communications network providing increased voice service for an ONT in accordance with an example embodiment of the present invention;

FIG. 3A is a block diagram of an ONT interacting with a Session Initiation Protocol (SIP) server in accordance with an example embodiment of the invention;

FIG. 3B is a block diagram of an exploded view of an ONT providing increased voice service;

FIG. 4 is a flow diagram illustrating a procedure of registering an ONT with a SIP server in accordance with an example embodiment of the present invention; and

FIG. 5 is a flow diagram illustrating the procedure of registering one or more user agents with an Analog Telephony Adapter (ATA) in accordance with an example embodiment of the present invention.

### DETAILED DESCRIPTION OF THE INVENTION

A description of example embodiments of the invention follows.

As demand for communications services grow in the world market, there is a corresponding demand to increase access to voice services. To increase access, the amount of hardware can increase or an expanded use of existing hardware can be done. Embodiments of the present invention leverage existing Session Initiation Protocol (SIP) and Analog Telephony Adaptor (ATA) technology to expand use of existing hardware to increase access to voice services for customers of a service provider.

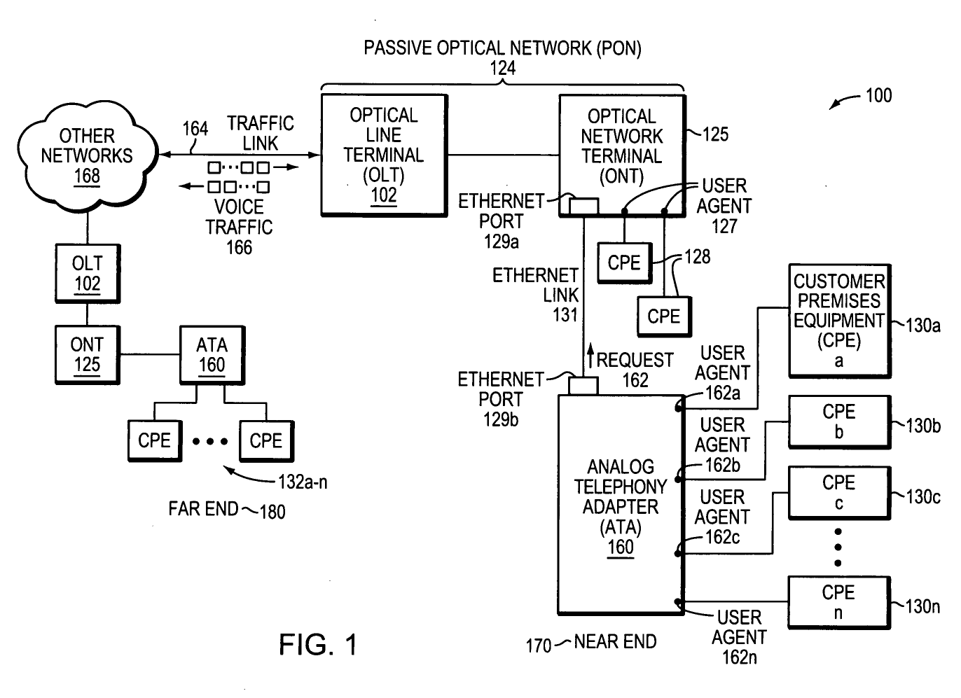

FIG. 1 is a block diagram of a communications network 100 providing increased voice service for an Optical Network Terminal (ONT) 125. In a traditional configuration, the ONT 125 has two voice ports, such as Ethernet port 129a, with respective user agents 127 and, as such, is limited to supporting communications for two Customer Premises Equipment (CPE) devices 128. Logical voice connections may be more than two (e.g., multi-line phones). An example embodiment of the present invention can increase connectivity to a communications network 100 via the ONT 125 by supporting an Analog Telephony Adapter expansion module (“ATA”) 160 (e.g., having multiple ATAs) with an Ethernet Link 131 between Ethernet ports 129a, 129b of the ONT 125 and the ATA 160, respectively. The Ethernet Link 131 is an example of a communications link that may be employed to support communications (e.g., digital) carrying voice signals or data between the ONT 125 and the ATA 160.

Other communications links may alternatively or combinatorily be employed. That is, the ATA 160 can support more than two CPE devices 130a-n and, thus, increases the number of connections between the ONT 125 and the CPE devices 130a-130n without modifying or adding hardware (e.g., adding voice ports) to the ONT 125. More specifically, in one example embodiment, the ONT 125 expands the number of user agents 127 available to the ONT 125 by adding the ATA 160 with multiple user agents 162a-n. The ATA 160 is configured as a SIP device that uses the same SIP messaging protocol as the ONT 125 through the use of a Session Initiation Protocol (SIP) server and a Dynamic Host Configuration Protocol (DHCP) server to establish a connection.

Once the ONT 125 and the OLT 102 establishes connectivity over the PON 124, the OLT 102 may send voice traffic 166 upstream via a traffic link 164 to other networks 168. As a result, the OLT 125 on a near end 170 accesses CPEs 132a-n on a far end 180 of the network. That is, by establishing connectivity over the PON 124, traffic communications between the ONT 125, OLT 102, and other nodes, such as CPEs 132a-n is possible. Other communications are also possible.

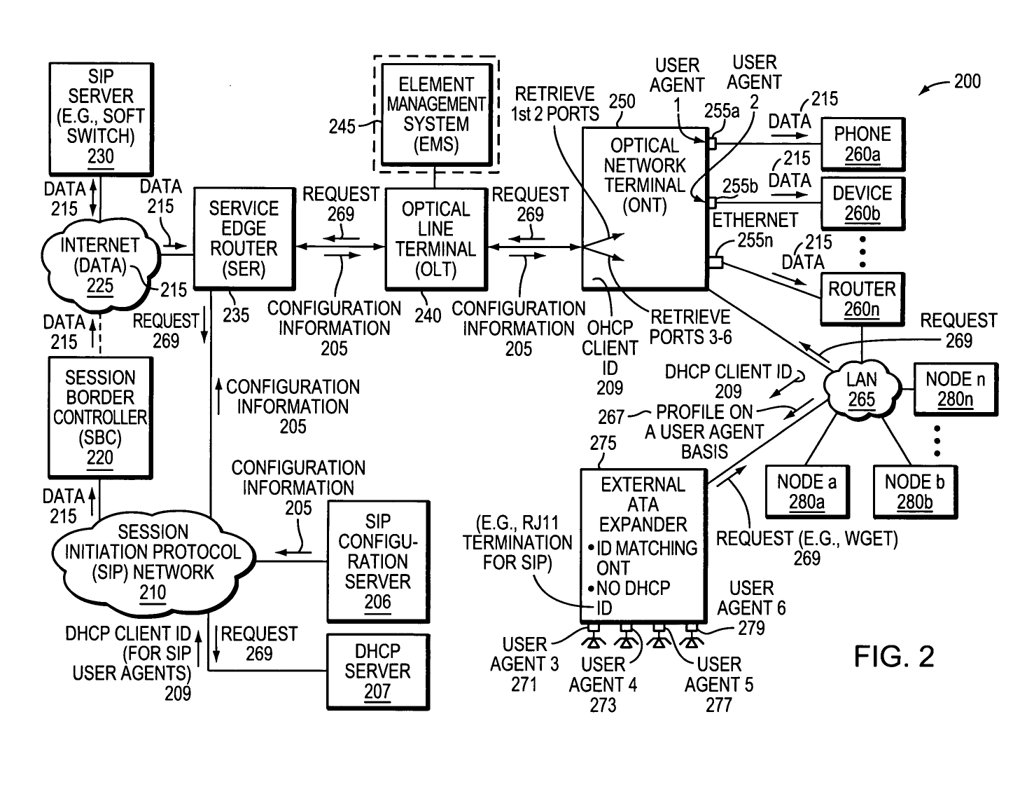

FIG. 2 is a detailed block diagram of a communications network 200 with increased access to voice services through use of an Analog Telephony Adapter expander (ATA) 275 supported by an Optical Network Terminal (ONT) 250. The communications network 200 includes an ONT 250, an Optical Line Terminal (OLT) 240, Element Management System (EMS) 245, Service Edge Router (SER) 235, Session Initiation Protocol (SIP) Network 210, SIP configuration server 206, Dynamic Host Configuration Protocol (DHCP) server 207, Session Border Controller (SBC) 220, Internet 225, SIP Server 230, multiple ports 255a-n, multiple devices 260a-n, Local Area Network (LAN) 265, multiple nodes 280a-n, the ATA expander 275, and user agents 271, 273, 277 and 279.

In operation, a user agent, such as user agents 271, 273, 277, 279 associated with respective ports, requests a connection via the ATA expander 275 to communicate using a port, such as ports 255a-255n, on the ONT 250. The ATA expander 275 sends a request 269 over a LAN 265 to the ONT 250. The ONT 250 forwards the request 269 (e.g., WGET) through the OLT 240 to the SER 235 for routing to the DHCP server 207. The SER 235 routes the request through the SIP Network 210 to the DHCP server 207 to obtain a Media Access Control (MAC) address or DHCP Client ID 209 for a user agent 271. The DHCP server 207 sends the user agent's 271 DHCP Client ID 209 (e.g., the MAC address for use by the user agent 271) to the ONT 250. The ONT 250, in turn, sends the ATA expander 275 the DHCP Client ID 209 to the user agent 271.

Once the external ATA expander 275 has the DHCP Client ID 209, the ATA performs multiple searches/requests for information (e.g., WGETs) over the SIP Network to a SIP configuration server 206 to retrieve a configuration profile and a user configuration profile (configuration information 205) for the user agent 271.

In a convenient example network illustration, the communications network 200 includes the SIP configuration server 206, which connects to the DHCP server 207, via a Wide Area Network (WAN), such as Internet 225. The SIP configuration server 206 communicates over a SIP network 210 to the OLT 240, which is in communication with the ONT 125, to obtain configuration information 205.

In an example embodiment, following connecting to the DHCP server 207, the ATA expander 275 issues a request 269 to the SIP configuration server 206 for configuration information 205. In particular, the ATA expander 275 issues a request 269 and sends the DHCP Client ID 209 to SIP server 230 to obtain a configuration profile on the SIP network 210. The SIP network 210 provides a phone number for the user agent 271 and an address for facilitating the connection on the SIP server 230. In one embodiment, the SIP network 210 provides the user agent 271 phone number, port ID of ONT 250, and dial plan and forwards the phone number, port ID of ONT 250, and dial plan to the ATA expander 275 for use with the user agent 271.

Using the phone number, port ID of ONT 250, and dial plan, the ATA expander 275 requests the user configuration information 205 for authenticating the user agent 271 on the SIP Network 210. That is, the ATA expander 275 sends the request 269, using the ONT 250, to the SIP configuration server 206 including the DHCP Client ID 209 of the user agent 271. Using the DHCP Client ID 209, the SIP configuration server 206 provides the ATA expander 275 with a user name and password for the user agent 271. After obtaining the user name and password for the user agent 271, the ONT 250 registers the user agent 271 with the SIP network 210 and creates a virtual cross connect between the ONT 250 and SIP server 230 (e.g., a soft switch). By creating a cross connect, data 215 (e.g., voice data) for the user agent 271 is passed between the SIP Network 210 and the SIP server 230. In this way, the SIP server 230 provides the user agent 271 with SIP signaling to activate the user agent 271 and to enable the user agent 271 to provide voice service. It is useful to note that the SIP configuration server 206 can store configuration information 205 in a database, memory, or the like.

By using SIP for facilitating increased voice service, many benefits are realized. For example, by using SIP, the ONT 250 receives access to features for an application-layer control (signaling) protocol for creating, modifying, and terminating sessions with at least one participant. Such features can be used to create two-party, multiparty, or multicast sessions that include Internet telephone calls, multimedia distribution, and multimedia conferences.

Moreover, the SIP is designed to be independent of an underlying transport layer and, as such, can operate on Transmission Control Protocol (TCP), User Datagram Protocol (UDP), and Stream Control Transmission Protocol (SCTP), among other protocols. Further, SIP can be transport-independent or text-based, allowing for readable SIP messages. Each feature provides the benefit of flexibility for allowing various types of services over the ONT 250. It should be understood that use of SIP is merely an example and other technologies, with similar benefits, can be used to activate or manage one or more user agents 271, 273, 277, 279.

It should be understood the ATA expander 275 can use a WGET or other suitable technique. In an example embodiment, the ATA expander 275 issues a request 269 and establishes a connection for a user agent on the ONT 250 port, such as ports 255a-255n, through receipt of SIP data from the SIP server 230. Thus, a single port 255a is being used by many user agents, such as user agents 271, 273, 277, 279. In an example embodiment, WGET is a software program that implements content retrieval from one or more web servers. WGET supports downloading via HTTP, HTTPS, and FTP protocols, TCP/IP-based protocols, and other similar technology. It should be understood that any search process or other way to obtain information is applicable to embodiments of the invention.

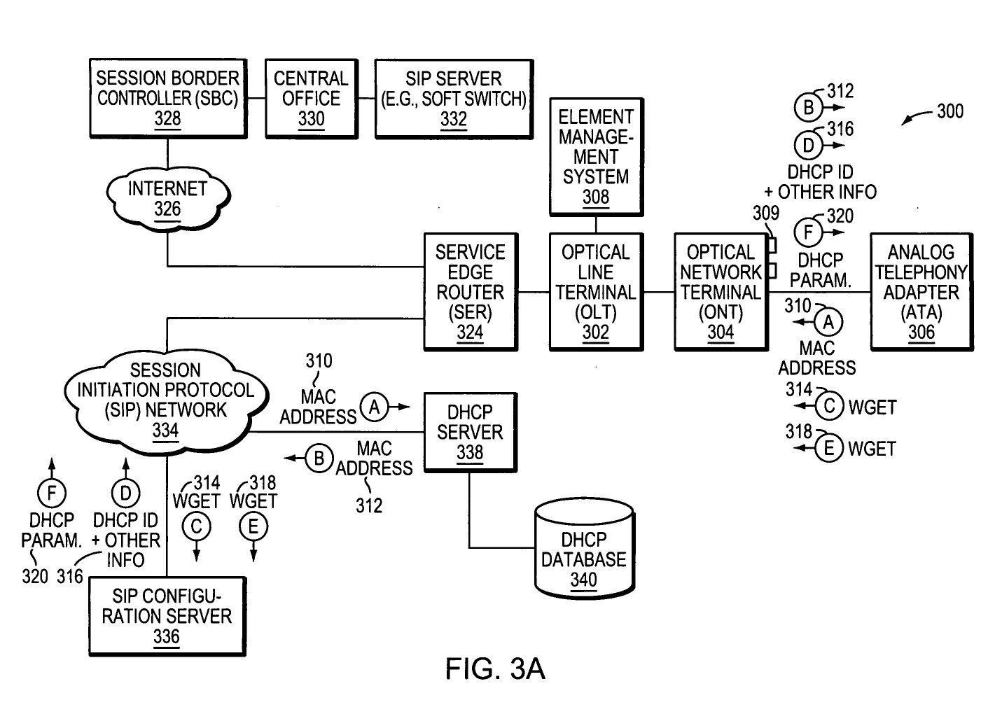

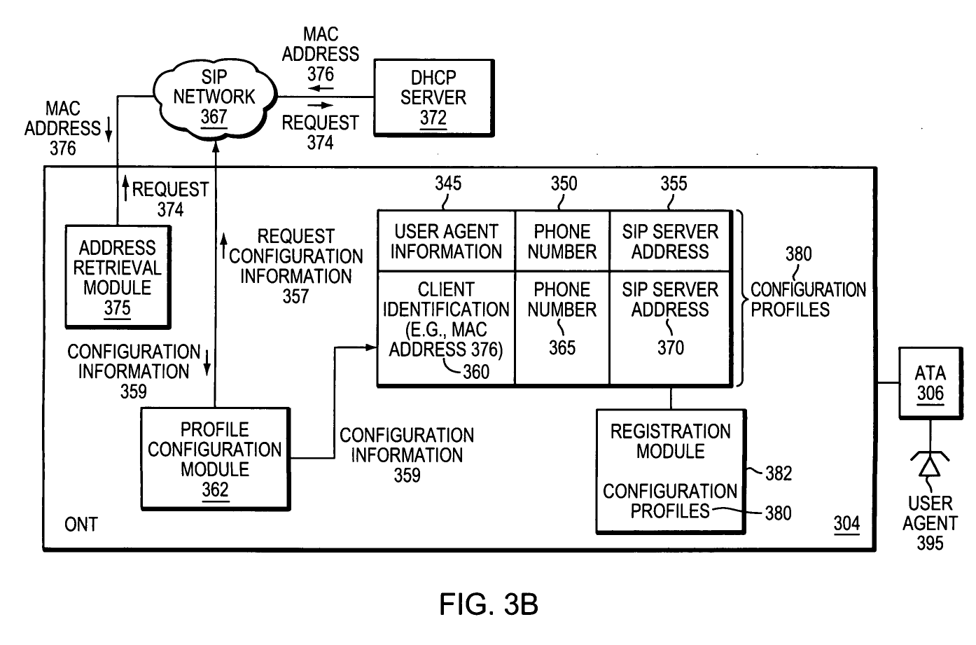

FIG. 3A depicts a communications network 300 forwarding signals between an Analog Telephony Adapter (ATA) 306 and a SIP configuration server 336, and a SIP Server 332 using an Optical Network Terminal (ONT) 304. Signaling is illustrated in this example embodiment as six stages, (A)-(F). Stage (A) signaling is used to request a MAC address for the ATA 306 and stage (B) receives the MAC address. Stage (C) issues an information request for an IP address of a SIP server and other connectivity information and Stage (D) receives the requested information. Stage (E) issues a request for a user configuration and Stage (F) receives the user configuration.

In operation, in stage (A) the ATA 306 sends a MAC address request 310 to the ONT 304, which forwards the MAC address request 310 through an Optical Line Terminal (OLT) 302, Element Management System 308, and Service Edge Router (SER) 324 to DHCP server 338 on SIP Network 334. After receiving the MAC Address request 310, the DHCP server 338 performs a lookup in a DHCP Database 340. As a result of the lookup, the DHCP server 338 determines an address for a user agent (not shown) connected to ATA 306 and returns a MAC Address 312, via the SIP Network 334, to the ATA 306 in stage (B). The MAC address 310 allows the ATA 306 to link communications to an Internet Protocol Address issued from the DHCP server 338.

After obtaining the MAC address 310, the ATA 306 determines configuration information for use by one or more user agents. In particular, the ATA 306 performs, in stage (C) a WGET 314 request through the ONT 304 to the SIP configuration server 336. In response to the WGET request 314, the SIP configuration server 336 returns, in stage (D) an IP address of a SIP server, a phone number (e.g., contact URI), a port ID, and a dial plan for use by the ATA 306. This information enables one or more user agents of the ATA 306 communicating on the ONT 304 port to communicate via the SIP Server 332. After retrieving the configuration information, the ATA 306 issues a second WGET, in stage (E), to the SIP configuration server 336 to obtain user configuration information for the user agent. The SIP configuration server 336, in stage (F), returns the user configuration information to the ATA 306. After obtaining the user configuration information, the ATA 306 establishes a connection for the user agent on a port 309 of ONT 304 through receipt of data from the SIP configuration server 336.

For example, a user agent communicating on the port 309 of the ONT 304, uses the ATA 306 and ONT 304 to obtain configuration profile information as shown in stages (A) through (F) of FIG. 3A. After obtaining the information, the user agent communicates through the central office 330 using a soft switch or SIP Server 332 through the SBC 328. In this way, the user agent is capable of communicating, via an analog user agent device, with a SIP Server 332 through the SBC 328. In an embodiment, the SBC 328 is a Voice over Internet Protocol (VoIP) session-aware device that controls call admission to a network at the border of that network, and optionally performs a host of call-control functions to ease the load on the call agents within the network. It should be understood that example embodiments of the invention facilitates allowing many user agents of the ONT 304 accessing one port 309, which is different from traditional systems that limit user agents to only two port connections.

FIG. 3B shows an exploded view of an ONT 304 containing an Address Retrieval Module 375, Profile Configuration Module 362, Registration Module 382, and user configuration profile 380. In operation, the ONT 304 receives a request from the ATA 306. In particular, the ATA 306 requests an Internet Protocol (IP) address from a Dynamic Host Configuration Protocol (DHCP) Server 372. The IP address corresponds to an address of a user agent 396 of the ATA 306. In particular, the ONT 304, using an address retrieval module 375, sends a request 374 through a SIP network 367 to the DHCP server 372. The DHCP server 372 returns a MAC address 376 (e.g., IP address) to the address retrieval module 375. The address retrieval module 375 stores the MAC address 376 in the configuration profiles 380 as client identification 360 for user agent information 345.

Next, the ATA 306 requests configuration information from the SIP network 367. More specifically, a profile configuration module 362 requests configuration information 357 from the SIP network 367. In turn, a configuration server on the SIP network 367 sends the configuration information 359 to the profile configuration module 362, which stores the configuration information 359 in the configuration profiles 380. The configuration information 359 typically includes a phone number 350 and a SIP server address 355. The retrieved configuration information 359 is stored as phone number 365 and SIP server address 370 in the configuration profiles 380.

After the configuration information is retrieved, a registration module 382 obtains the configuration profiles 380 and registers the user agent 395 of the ATA 306 to activate voice service for the user agent 395 using data from the SIP network 367. It should be understood that the use of address retrieval module 375, the profile configuration module 362, the registration module 382, and the configuration profiles 380 of the ONT 304 is merely for illustrative purposes. That is, the ONT 304 may include any combination of these modules and configuration profile 380. Alternatively, these modules may exist externally to ONT 304 or in some combination thereof. It should further be understood that the configuration profiles 380 may also be stored in a database or other suitable memory or within ONT 304 as shown in FIG. 3B. Further, storing configuration profiles in an ATA, ONT, or database may use volatile or non-volatile memory.

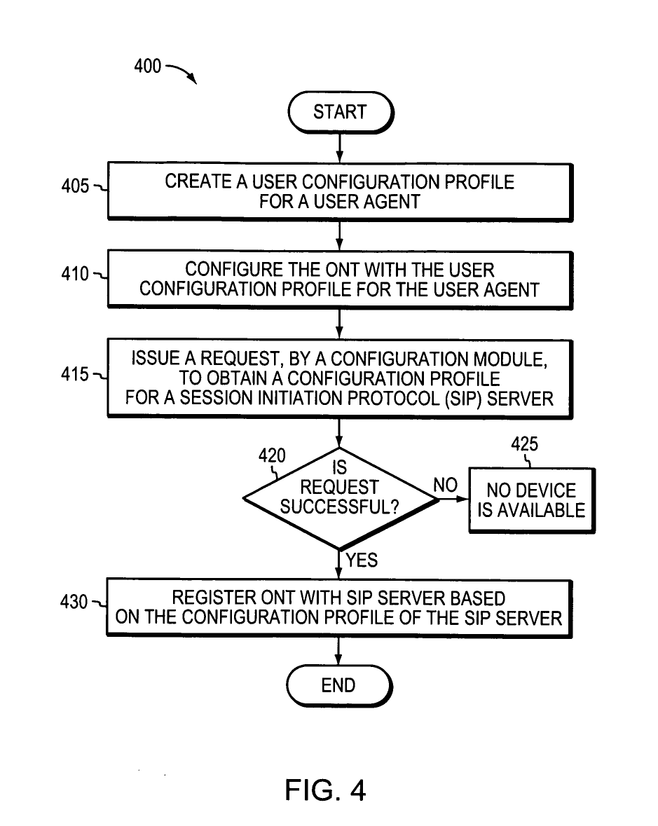

FIG. 4 depicts a flow diagram for registering an ONT with a SIP server to increase voice service over an ONT port. After beginning, a procedure 400 creates a user configuration file for use by at least one user agent in 405. Next, the procedure 400 configures an ONT with the user configuration profile for the User Agent (410), which can be obtained as described above. Specifically, the procedure 400 issues a request, by a configuration module, to obtain a configuration profile for a Session Initiation Protocol (SIP) Server (415) to ensure the SIP Messaging Protocol used is the same as the ONT. Next, if the request is successful (420), the procedure 400 registers the ONT with the SIP server based on the configuration file of the SIP Server (430). If the request is not successful, the procedure 400 indicates that no device is available for connection (425). In this way, the procedure 400 provides for registering an ONT on a SIP network.

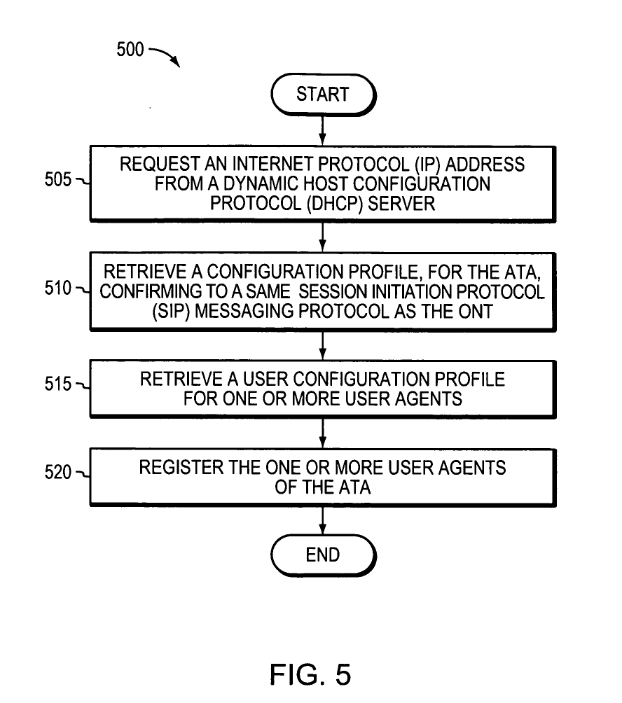

FIG. 5 shows a flow diagram for registering one or more user agents of an Analog Telephony Adaptor. After beginning, a procedure 500 requests an Internet Protocol (IP) Address from a Dynamic Host Configuration Protocol (DHCP) Server 505. The IP address is used in obtaining a configuration profile. Next, the procedure 500, using the IP address retrieves a user agent configuration profile. The user agent configuration profile typically conforms to a same Session Initiation Protocol (SIP) message and protocol as used by the ONT (510), thereby allowing voice service connectivity through receipt of SIP network data. Next, the procedure 500 retrieves a User Configuration Profile for one or more user agents (515) for authenticating the user agent on the SIP network. The procedure 500 registers one or more user agents of the ATA (520) by providing connection for the user agents to a SIP server using the configuration profiles.

It should be understood that any of the procedures disclosed herein, such as increasing voice service or the flow diagrams of FIGS. 4 and 5, may be implemented in the form of hardware, firmware, or software. If implemented in software, the software may be processor instructions in any suitable software language and stored on any form of computer readable medium. The processor instructions are loaded and executed by a processor, such as a general purpose or application specific processor, that, in turn, performs the example embodiments disclosed herein.

While this invention has been particularly shown and described with references to example embodiments thereof, it will be understood by those skilled in the art that various changes in form and details may be made therein without departing from the scope of the invention encompassed by the appended claims.

What is claimed is:

1. A method of increasing voice service for an ONT, comprising:
requesting an Internet Protocol (IP) address from a Dynamic Host Configuration Protocol (DHCP) server upstream of an Optical Network Terminal (ONT), the IP address corresponding to an address of an Analog Telephony Adapter (ATA) coupled to the ONT on a downstream side of the ONT;
retrieving a configuration profile, for the ATA, conforming to a same Session Initiation Protocol (SIP) messaging protocol as used by the ONT;
retrieving a user configuration profile for at least one user agent in the ATA to enable the at least one user agent to register with a SIP server upstream of the ONT; and
registering the at least one user agent of the ATA by using the configuration profiles to activate the at least one user agent for SIP service.

2. The method according to claim 1 wherein retrieving a user configuration profile includes selectively retrieving a user configuration for particular user agents.

3. The method according to claim 1 further comprising:
parsing the user configuration profile of the at least one user agent; and
storing the user configuration profile for each user agent in memory of the ATA.

4. The method according to claim 1 wherein the configuration profile for the ATA includes configuration profiles for N ports.

5. The method according to claim 1 wherein the IP address is an Ethernet or Media Access Control (MAC) address.

6. The method according to claim 1 further including communicating with the DHCP server via a wireless interface.

7. The method according to claim 1 wherein the ATA is in a network external from a network that includes the ONT and DHCP server.

8. The method according to claim 1 wherein retrieving the configuration profile, user configuration profile, or both includes retrieving an Extensible Markup Language (XML) file.

9. The method according to claim 1 further comprising performing the requesting, retrieving, retrieving, and registering for a device coupled to the ONT on a downstream side of the ONT.

10. The method according to claim 9 wherein the device is a SIP phone or personal computer.

11. An apparatus for increasing voice service of an ONT, comprising:
an address retrieval module configured to request an Internet Protocol (IP) address from a Dynamic Host Configuration Protocol (DHCP) server upstream of an Optical Network Terminal (ONT), the IP address corresponding to an address of an Analog Telephony Adapter (ATA) coupled to the ONT on a downstream side of the ONT;
a profile configuration module configured to retrieve a configuration profile, for the ATA, conforming to a same Session Initiation Protocol (SIP) messaging protocol as the ONT and to retrieve a user configuration profile for at least one user agent in the ATA to enable the at least one user agent to register with a SIP server upstream of the ONT; and
a registration module configured to register the at least one user agent of the ATA, using the configuration profiles to activate the at least one user agent for SIP service.

12. The apparatus according to claim 11 wherein the profile configuration module is further configured for selective retrieve of a user configuration for particular user agents.

13. The apparatus according to claim 11 wherein the profile configuration module is further configured to:
parse the user configuration profile of the at least one user agent; and
store the user configuration profile for each user agent in memory of the ATA.

14. The apparatus according to claim 11 wherein the configuration profile for the ATA includes configuration profiles for N ports.

15. The apparatus according to claim 11 wherein the IP address is an Ethernet or Media Access Control (MAC) address.

16. The apparatus according to claim 11 the address retrieval module is further configured to communicate with the DHCP server via a wireless interface.

17. The apparatus according to claim 11 wherein the ATA is in a network external from a network that include the ONT and DHCP server.

18. The apparatus according to claim 11 wherein the profile configuration module is further configured to retrieve an Extensible Markup Language (XML) file for the configuration profile, user configuration profile, or both.

19. The apparatus according to claim 11 wherein:
the profile configuration module is further configured to perform the request, retrieve, and retrieve for a device coupled to the ONT on a downstream side of the ONT; and
the registration module is further configure to register the device coupled to the ONT on a downstream side of the ONT.

20. The apparatus according to claim 19 wherein the device is a SIP phone or personal computer.
